(19) United States
(12) Patent Application Publication
(10) Pub. No.: US 2023/0102065 A1
(43) Pub. Date: Mar. 30, 2023

(54) BATTERY PACK

(71) Applicant: SK ON CO., LTD., Seoul (KR)

(72) Inventors: Jin Su HAN, Daejeon (KR); Min Song KANG, Daejeon (KR); Ju Yong PARK, Daejeon (KR); Sei Hoon CHO, Daejeon (KR); Ji Woong KIM, Daejeon (KR); Byeong Jun PAK, Daejeon (KR)

(21) Appl. No.: 17/958,100

(22) Filed: Sep. 30, 2022

(30) Foreign Application Priority Data
Sep. 30, 2021 (KR) 10-2021-0129489

(51) Int. Cl. H01M 50/291; H01M 50/296; H01M 50/298

(52) U.S. Cl. CPC H01M 50/291; H01M 50/296; H01M 50/298

(57) ABSTRACT

A battery pack includes: a pack housing having an internal space; at least one cell stack body accommodated in the internal space of the pack housing; at least one electronic component accommodated in the internal space of the pack housing; a connecting member electrically connected to at least one of the at least one cell stack body and the at least one electronic component; and a partition wall partitioning the internal space and accommodating at least a portion of the connecting member.

### CROSS-REFERENCE TO RELATED APPLICATION(S)

This patent document claims the priority and benefits of Korean Patent Application No. 10-2021-0129489 filed in the Korean Intellectual Property Office on Sep. 30, 2021, the disclosure of which is incorporated herein by reference in its entirety.

### TECHNICAL FIELD

The present disclosure relates to technology related to a battery pack.

### BACKGROUND

A secondary battery is a battery which may be charged and discharged unlike a primary battery which is unable to be charged, and may be applied not only to a portable device, but also to an electric vehicle (EV), a hybrid electric vehicle (HEV) or the like, driven by an electric driving source. Types of secondary batteries currently widely used may include a lithium ion battery, a lithium polymer battery, a nickel cadmium battery, a nickel hydrogen battery, a nickel zinc battery and the like. An operation voltage of a unit cell of the secondary battery, that is, a unit cell of the battery, may be about 2.5 V to 4.6 V. Therefore, when a higher output voltage is required, the plurality of battery cells may be connected in series to each other to form a battery pack. In addition, the plurality of battery cells may be connected to each other in parallel to form the battery pack, based on a charge/discharge capacity required for the battery pack. Accordingly, the number of battery cells included in the battery pack may be variously set based on the required output voltage or charge/discharge capacity.

Various electronic components such as various battery modules, a battery management system (BMS) and a power relay assembly (PRA) may be positioned in the battery pack, and these electronic components may be connected to each other by electronic wiring. For example, the electronic components may be connected to each other by the electronic wiring such as a wiring harness or a bus bar, which may transmit electric power or an electrical signal.

In some implementations, a general battery pack may include a low voltage (LV) harness having a large number of wires in order to obtain information on a plurality of battery modules included in the battery pack. However, the LV harness may have a complicated shape and may occupy a relatively large amount of space. In addition, when an event such as a cell ignition occurs in the battery pack, the LV harness in a complicated arrangement may act as a factor which may aggravate the event, such as blocking a gas flow path.

### SUMMARY

The disclosed technology can be implemented in some embodiments to provide a battery pack having efficient internal space by effectively arranging electronic wiring such as a wiring harness and a bus bar therein. The disclosed technology can also be implemented in some embodiments to provide a battery pack which may prevent electronic wiring therein from aggravating thermal runaway or heat propagation in the pack.

According to an aspect of the present disclosure, a battery pack may include: a pack housing having an internal space; at least one cell stack body accommodated in the internal space of the pack housing; at least one electronic component accommodated in the internal space of the pack housing; a connecting member electrically connected to at least one of the at least one cell stack body and the at least one electronic component; and a partition wall partitioning the internal space and accommodating at least a portion of the connecting member

The partition wall may include a void therein, and the connecting member may be accommodated in the void.

The partition wall may include a lower frame and an upper frame, coupled to the lower frame, and the void may be formed between the lower frame and the upper frame.

The partition wall may include a recess in a side surface, and the connecting member may be accommodated in the recess.

The connecting member may include a conductive member and an insulating member surrounding the conductive member.

The connecting member may be a bus bar connected to an input/output port of the at least one cell stack body.

The at least one electronic component may be a battery management system (BMS), and the connecting member may be a low voltage (LV) harness connected to the battery management system.

The partition wall may include a void and a recess, each accommodating the connecting member, and the void and the recess may be spatially separated from each other.

In another aspect, the disclosed technology can be implemented to provide a battery pack that includes a housing structured to enclose an internal space; partition walls located in the internal space of the housing and engaged to the housing to separate the internal space into an array of separate accommodation spaces; a plurality of battery modules disposed inside the separate accommodation spaces, respectively, one battery module per accommodating space, each battery module including one or more battery cells, one or more electronic components located in the internal space of the housing; and electrical connectors electrically coupled to provide electrical connections to the battery modules and the one or more electronic components. One or more partition walls are structured to accommodate at least a portion of one or more of the electrical connectors.

The above and other aspects and implementations of the disclosed technology are described in greater detail in the drawings, the description and the claims.

### BRIEF DESCRIPTION OF DRAWINGS

The above and other aspects, features and advantages of the present disclosure will be more clearly understood from the following detailed description taken in conjunction with the accompanying drawings, in which:

FIG. 1 illustrates a battery pack according to an exemplary embodiment;

FIG. 2 illustrates a component in a pack housing and a connecting member connected to the components;

FIG. 3 illustrates the connecting member accommodated in a partition wall in an exemplary embodiment;

FIG. 4 illustrates a method of assembling the connecting member in the partition wall;

FIG. 5 illustrates the connecting member accommodated in a recess of the partition wall in an exemplary embodiment;

FIGS. 6 and 7 each illustrate that the connecting member is accommodated in a side surface of the partition wall according to an exemplary embodiment; and

FIG. 8 is a view illustrating the connecting members accommodated in an internal space and the recess of the partition wall in an exemplary embodiment.

### DETAILED DESCRIPTION

Hereinafter, exemplary embodiments in the present disclosure will now be described in detail with reference to the accompanying drawings.

In this specification, an X-direction, a Y-direction and a Z-direction may indicate a direction parallel to an X axis, a direction parallel to a Y axis, and a direction parallel to a Z axis, each illustrated in the drawings. In addition, unless otherwise described, the X-direction may be a concept including both a +X axis direction and a −X axis direction, which may be equally applied to the Y-direction and the Z-direction.

In this specification, a case in which two directions (or axes) are parallel to or perpendicular to each other may also include a case in which the two directions (or axes) are substantially parallel or substantially parallel to each other. For example, a case in which the first axis and the second axis are perpendicular to each other may indicate a case in which the first axis and the second axis form an angle of 90 degrees or an angle close to 90 degrees.

In this specification, a paragraph beginning with “in an exemplary embodiment” may not necessarily indicate the same embodiment. Particular features, structures, or characteristics may be coupled to each other in any suitable manner consistent with the present disclosure.

In this specification, an expression, “configured to” may indicate that a component includes a structure necessary to implement a certain function.

Hereinafter, an exemplary embodiment of the present disclosure will be described in detail with reference to the drawings. However, a spirit of the present disclosure is not limited to the described exemplary embodiment. For example, those skilled in the art, understanding the spirit of the present disclosure, may suggest another exemplary embodiment included in a scope of the spirit of the present disclosure by adding, changing or deleting the component, and another exemplary embodiment will be construed as being included in the scope of the spirit of the present disclosure.

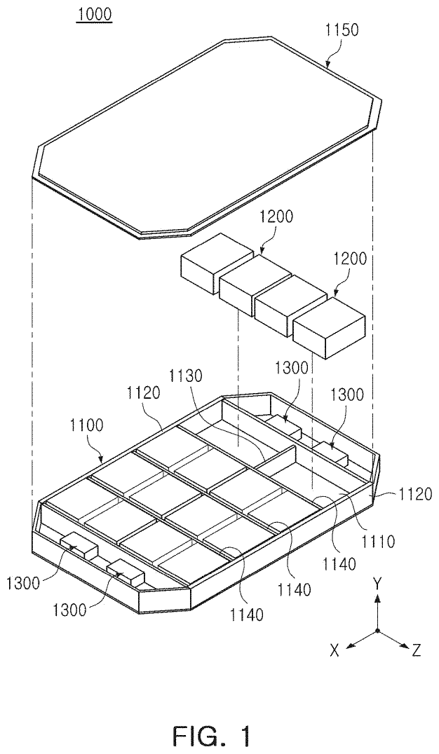

FIG. 1 illustrates a battery pack 1000 according to an exemplary embodiment. Referring to FIG. 1, the battery pack 1000 in an exemplary embodiment may include a pack housing 1100 and a plurality of cell stack bodies 1200 accommodated in the pack housing 1100. The pack housing 1100 may include a lower plate 1110, a side plate 1120 disposed on an edge of the lower plate 1110, a partition wall 1130 partitioning a space surrounded by the side plate 1120 and an upper plate 1150 disposed on the cell stack bodies 1200. The upper plate 1150 and/or the lower plate 1110 may function as a cooling plate. The lower plate 1110 and/or the upper plate 1150 may be in direct or indirect contact with the cell stack bodies 1200 to dissipate heat generated in the cell stack bodies 1200. For example, at least one of the lower plate 1110 and the upper plate 1150 may include a flow path through which a refrigerant flows.

An internal space of the pack housing 1100 may be divided into several compartments by the partition wall 1130, and at least one cell stack body 1200 may be disposed in each compartment. FIG. 1 illustrates that one cell stack body 1200 is disposed in one compartment, which is only an example, and two or more cell stack bodies 1200 may be disposed therein. In addition, FIG. 1 illustrates that four electronic components 1300 are disposed in the pack housing 1100, which is only an example, and the number or positions of the electronic components 1300 in another exemplary embodiment may differ from those in the described exemplary embodiment.

At least one electronic component 1300 may be disposed in the pack housing 1100. In the present disclosure, the electronic component 1300 may include a battery management system (BMS), a power relay assembly (PRA), a electric power management device, a battery charge/discharge device, and an input port of the battery pack 1000, an output port of the battery pack 1000, a device for sensing a battery state (e.g. voltage, lifespan, temperature, pressure or the like), a device for battery safety, an electric power cut-off system, a device for slow or fast charging, etc. Even a device not explicitly mentioned in the present disclosure may be included in the electronic component 1300 of the present disclosure as long as the device is an electronic device disposed in the battery pack 1000.

The battery pack 1000 may include a connecting member 1400 electrically connecting two or more of the cell stack bodies 1200 or the electronic components 1300 to each other. For example, the cell stack body 1200 may be electrically connected to another cell stack body 1200 in the battery pack 1000 by the connecting member 1400. For another example, the electronic component 1300 may be electrically connected to another electronic component 1300 in the battery pack 1000 by the connecting member 1400. For yet another example, the cell stack body 1200 may be electrically connected to the electronic component 1300 in the battery pack 1000 by the connecting member 1400.

The connecting member 1400 may electrically connect at least two different components in the battery pack 1000 to each other. For example, the connecting member 1400 may be a wiring harness or a bus bar.

According to an exemplary embodiment of the present disclosure, the connecting member 1400 may be an electronic wiring for high voltage or an electronic wiring for low voltage.

For example, a high current may flow between the cell stack bodies 1200, and the connecting member 1400 connecting the cell stack bodies 1200 to each other may thus be the electronic wiring for high voltage. For another example, when the electronic component 1300 is a component for charging the battery pack 1000, the connecting member 1400 connected to the corresponding electronic component 1300 may be the electronic wiring for high voltage. In some implementations, the connecting member 1400 electrically connecting the battery management system (BMS) and the cell stack body 1200 to each other may be the electronic wiring for low voltage.

According to another exemplary embodiment of the present disclosure, the connecting member 1400 may be a bus bar connected to the input/output port (or port block) of the cell stack body 1200.

For example, the connecting member 1400 may be a low voltage (LV) harness connected to the battery management system (BMS).

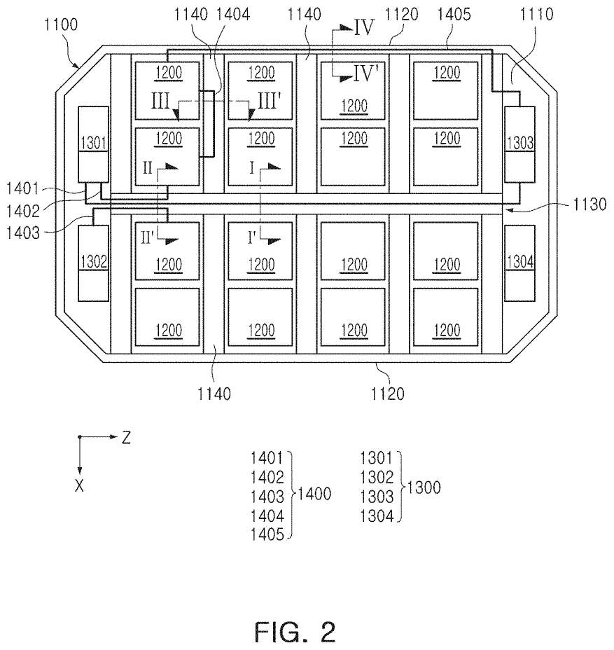

FIG. 2 illustrates the component in the battery pack 1000 and the connecting member connected to the components. Referring to FIG. 2, the connecting member 1400 may electrically connect the electronic component 1300 and the cell stack body 1200 to each other, or electrically connect the electronic components 1300 to each other or the cell stack bodies 1200 to each other.

FIG. 2 illustrates, as an example of the connecting member 1400, a first connecting member 1401 connecting a first electronic component 1301 and a third electronic component 1303 to each other, a second connecting member 1402 connecting the first electronic component 1301 and the cell stack body 1200 to each other, a third connecting member 1403 connecting a second electronic component 1302 and the cell stack body 1200 to each other, a fourth connecting member 1404 connecting the cell stack bodies 1200 to each other, and a fifth connecting member 1405 connecting the third electronic component 1303 and the cell stack body 1200 to each other.

The first to fifth connecting members 1401, 1402, 1403, 1404 and 1405 illustrated in FIG. 2 are only examples for convenience of description, and an exemplary embodiment of the present disclosure is not limited thereto. That is, the battery pack 1000 may include another type connecting member or an additional connecting member different from the first to fifth connecting members 1401, 1402, 1403, 1404 and 1405 illustrated in FIG. 2.

In an exemplary embodiment, the pack housing 1100 may include the partition wall 1130 and 1140, partitioning the internal space of the pack housing 1100. The pack housing 1100 may include a first partition wall 1130 passing through the internal space in the X-direction. Also, the pack housing 1100 may include a second partition wall 1140 passing through the internal space in the Z-direction. The partition walls 1130 and 1140 illustrated in FIGS. 1 and 2 are only examples, and an exemplary embodiment of the present disclosure is not limited thereto.

In an exemplary embodiment, at least a portion of the connecting member 1400 may be accommodated in the partition wall 1130 or 1140. In an exemplary embodiment, the partition wall 1130 or 1140 may include an accommodation portion accommodating the connecting member 1400. For example, the accommodation portion may be an internal space of the partition wall 1130 or 1140. For another example, the accommodation portion may be a recess formed in a side surface of the partition wall 1130 or 1140.

According to an exemplary embodiment of the present disclosure, the connecting member 1400 may be accommodated in the partition wall 1130 or 1140, and an internal space of the battery pack 1000 may thus be efficiently utilized.

A conventional battery pack may have insufficient internal space, and a connecting member such as the wiring harness or a bus bar for high voltage may thus be positioned in a space between a partition wall and an upper plate.

However, in the battery pack 1000 according to an exemplary embodiment of the present disclosure, at least a portion of the connecting member 1400 may be accommodated in the partition wall 1130 or 1140, and the partition wall 1130 or 1140 may be extended relatively close to the upper plate 1150 from the lower plate 1110. When the partition wall 1130 or 1140 is extended relatively close to the upper plate 1150 from the lower plate 1110, it is possible to suppress propagation of flame, gas or heat between spaces partitioned by the partition wall 1130 or 1140, which may delay or prevent thermal runaway of the battery pack 1000.

In some implementations, a general battery pack may include a plurality of battery modules, and the LV harness having a large number of wires in order to obtain information on the plurality of modules may have a complicated shape and occupy a relatively large amount of space. In addition, when an event such as a cell ignition occurs in the battery pack, the LV harness in a complicated arrangement may act as a factor which may aggravate the event, such as blocking a gas flow path.

On the other hand, according to an exemplary embodiment of the present disclosure, the LV harness may be accommodated in the partition wall 1130 or 1140, thereby preventing the above problem.

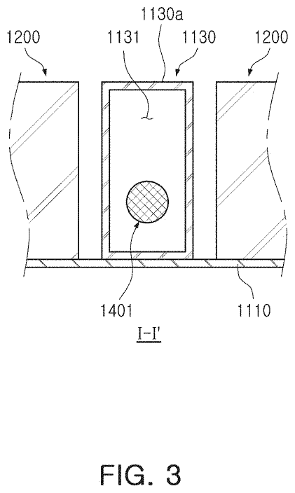

FIG. 3 illustrates the connecting member 1400 accommodated in the partition wall 1130 in an exemplary embodiment. FIG. 3 illustrates an example of a cross section of the first partition wall 1130 taken along line I-I′ in FIG. 2.

Referring to FIG. 3, the first connecting member 1401 may be accommodated in the first partition wall 1130. In detail, the first partition wall 1130 may include a void 1131 therein, and the first connecting member 1401 may be accommodated in the void 1131. For example, the first partition wall 1130 may have a shape of a hollow square beam, and the first connecting member 1401 may be disposed in the square beam.

Referring to FIG. 2 together, the first connecting member 1401 may be extended in the first partition wall 1130 in a length direction (i.e., X-direction) of the first partition wall 1130, and let out from each of one and the other ends of the first partition wall 1130 to be connected to the electronic component 1300. FIG. 2 illustrates that the first connecting member 1401 connects the first electronic component 1301 and the third electronic component 1303 to each other, which is only an example. In another exemplary embodiment, one end of the first connecting member 1401 may be connected to the first electronic component 1301, and the other end of the first connecting member 1401 may be connected to the cell stack body 1200.

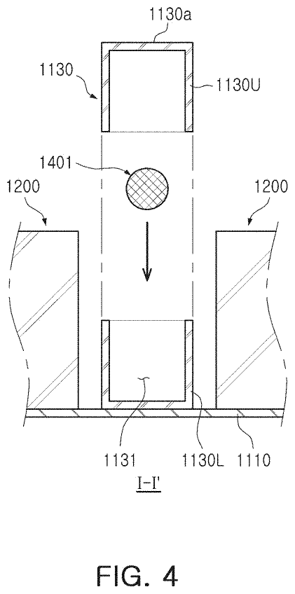

FIG. 4 illustrates a method of assembling the connecting member 1400 in the partition wall 1130. Referring to FIG. 4, the first partition wall 1130 may include a lower frame 1130L and an upper frame 1130U. In a state where the first connecting member 1401 is disposed in the lower frame 1130L, the upper frame 1130U may be coupled to the lower frame 1130L, and the first connecting member 1401 may thus be accommodated in the first partition wall 1130. For example, the lower frame 1130L and the upper frame 1130U may be welded to each other or coupled to each other by using mechanical fastening means such as bolt-nut coupling.

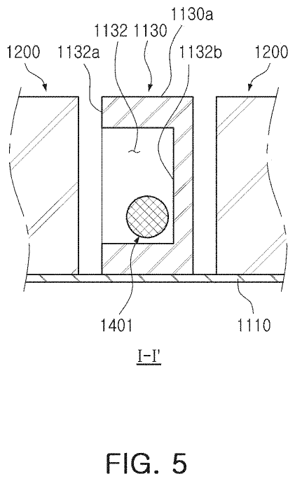

FIG. 5 illustrates the connecting member accommodated in the recess of the partition wall in an exemplary embodiment. FIG. 5 illustrates another example of a cross section of the first partition wall 1130 taken along line I-I′ in FIG. 2. Referring to FIG. 5, the first partition wall 1130 in an exemplary embodiment may include a recess 1132 accommodating the first connecting member 1401. For example, the first partition wall 1130 may include a side surface 1132a extended from each of two ends of an upper surface 1130a to the lower plate 1110, and a recessed surface 1132b inward from the side surface 1132a may be defined as a portion of the recess 1132.

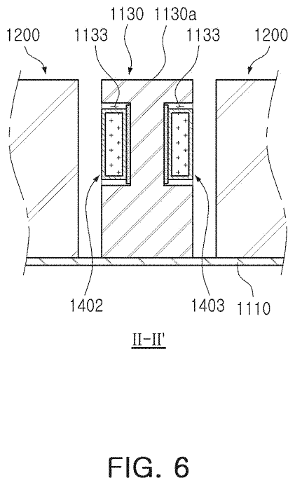

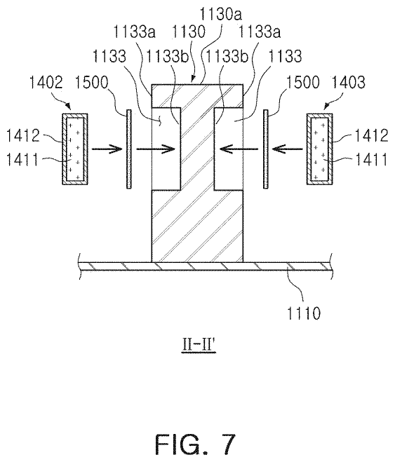

FIGS. 6 and 7 each illustrate that the connecting member 1400 is accommodated in each of two side surfaces of the partition wall 1130 according to an exemplary embodiment. FIG. 6 schematically illustrates the first partition wall 1130, the second connecting member 1402, and the third connecting member 1403, based on a cross section taken along line II-II′ of the battery pack 1000 in FIG. 2.

In an exemplary embodiment, the second connecting member 1402 and the third connecting member 1403 may be accommodated in the first partition wall 1130. The first partition wall 1130 may include a side surface 1133a extended from each of two ends of the upper surface 1130a to the lower plate 1110, and a recessed surface 1133b inward from the side surface 1133a to form a recess 1133. The recess 1133 may have a depth corresponding to a thickness of the connecting member 1400. For example, when the connecting member 1400 is accommodated in the first partition wall 1130, an outer surface of the connecting member 1400 may coincide with or approximately coincide with the side surface 1133a of the first partition wall 1130.

Referring to FIG. 7, the connecting member 1400 may include a conductive member 1411 and an insulating member 1412 surrounding at least a portion of the conductive member 1411 to insulate the first partition wall 1130 and the conductive member 1411 from each other. The connecting member 1400 may be mounted in the first partition wall 1130 by using an adhesive member 1500.

Referring to FIG. 2 together, the second connecting member 1402 and the third connecting member 1403 may be connected to the electronic component 1300 and the cell stack body 1200, which is only an example. The second connecting member 1402 or the third connecting member 1403 may connect the electronic components 1300 to each other or the cell stack bodies 1200 to each other.

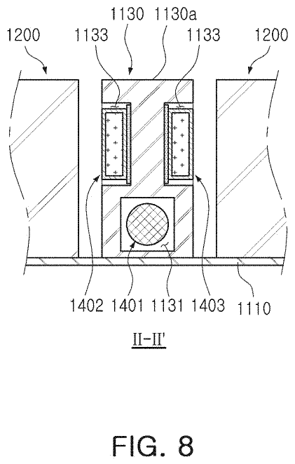

FIG. 8 illustrates the connecting member 1400 accommodated in the partition wall 1130 in an exemplary embodiment. FIG. 8 illustrates an example of a cross section of the first partition wall 1130 taken along line II-II′ in FIG. 2.

In an exemplary embodiment, the partition wall may include the accommodation portions respectively accommodating two or more connecting members. The respective accommodation portions may be spatially separated from each other.

For example, referring to FIG. 8, the first partition wall 1130 may include the void 1131 therein and the recess 1133 formed in the side surface. The first connecting member 1401 may be accommodated in the void 1131 in the first partition wall, and the second connecting member 1402 and the third connecting member 1403 may be accommodated in the recesses 1133. In addition, the void 1131 and the recess 1133 may be spatially separated from each other.

FIGS. 6 through 8 illustrate that the recess 1133 accommodating the connecting member 1400 is disposed in each of the two side surfaces of the first partition wall 1130, which is only an example. In another exemplary embodiment, the recess 1133 may be disposed only in one side surface of the first partition wall 1130.

FIGS. 3 through 8 illustrate the connecting member 1400 accommodated in the first partition wall 1130, which is for convenience of description, and a structure included in the pack housing 1100 in addition to the first partition wall 1130 may accommodate the connecting member 1400.

In an exemplary embodiment, the connecting member 1400 may also be partially accommodated in the second partition wall 1140 or the side frame 1120. That is, the second partition wall 1140 or the side frame 1120 may include an accommodation portion accommodating at least a portion of the connecting member 1400. The accommodation portion may be a void formed in the second partition wall or the side frame or a recess formed in an outer side surface thereof.

Referring to FIG. 2, a portion of the fourth connecting member 1404 may be accommodated in the second partition wall 1140, and a portion of the fifth connecting member 1405 may be accommodated in the side frame 1120. That is, the fourth connecting member 1404 and the second partition wall 1140 may each be disposed in a shape similar to that of FIG. 3, 5 or 6, based on a cross section taken along line III-III′ of FIG. 2. In addition, the fifth connecting member 1405 and the side frame 1120 may each have a shape similar to that of FIG. 3, 5 or 6, based on a cross section taken along line IV-IV′ of FIG. 2.

As set forth above, according to an exemplary embodiment of the present disclosure, the battery pack may have the efficient internal space by effectively arranging the electronic wiring such as the wiring harness and the bus bar therein. In addition, according to an exemplary embodiment of the present disclosure, it is possible to prevent or minimize the thermal runaway or the heat propagation in the battery pack.

While exemplary embodiments have been shown and described above, it will be apparent to those skilled in the art that modifications and variations could be made without departing from the scope of the present disclosure as defined by the appended claims.

What is claimed is:

1. A battery pack comprising:
a pack housing structured to enclose an internal space;
at least one cell stack body accommodated in the internal space of the pack housing;
at least one electronic component accommodated in the internal space of the pack housing;
a connecting member electrically connected to at least one of the at least one cell stack body and the at least one electronic component; and
a partition wall partitioning the internal space and accommodating at least a portion of the connecting member.

2. The battery pack of claim 1, wherein the partition wall includes a void in the partition wall, and the connecting member is accommodated in the void.

3. The battery pack of claim 2, wherein the partition wall includes a lower frame and an upper frame, coupled to the lower frame, and the void is formed between the lower frame and the upper frame.

4. The battery pack of claim 1, wherein the partition wall includes a recess in a side surface, and the connecting member is accommodated in the recess.

5. The battery pack of claim 1, wherein the connecting member includes a conductive member and an insulating member surrounding the conductive member.

6. The battery pack of claim 1, wherein the connecting member is a bus bar connected to an input/output port of the at least one cell stack body.

7. The battery pack of claim 1, wherein the at least one electronic component is a battery management system (BMS), and the connecting member is a low voltage (LV) harness connected to the battery management system.

8. The battery pack of claim 1, wherein the partition wall includes a void and a recess, each accommodating the connecting member, and the void and the recess are spatially separated from each other.

9. A battery pack comprising:
a housing structured to enclose an internal space;
partition walls located in the internal space of the housing and engaged to the housing to separate the internal space into an array of separate accommodation spaces;
a plurality of battery modules disposed inside the separate accommodation spaces, respectively, one battery module per accommodating space, each battery module including one or more battery cells;
one or more electronic components located in the internal space of the housing; and
electrical connectors electrically coupled to provide electrical connections to the battery modules and the one or more electronic components,
wherein one or more partition walls are structured to accommodate at least a portion of one or more of the electrical connectors.

10. The battery pack of claim 9, wherein at least one partition wall includes a void in which a portion of one or more of the electrical connectors is located.

11. The battery pack of claim 9, wherein at least one of the partition walls includes a lower frame and an upper frame, coupled to the lower frame to form a void between the lower frame and the upper frame for accommodating a portion of one or more of the electrical connectors.

12. The battery pack of claim 9, wherein at least one of the partition walls includes a recess in a side surface, and the portion of one or more of the electrical connectors is accommodated in the recess.
